(19) United States
(12) Patent Application Publication
(10) Pub. No.: US 2016/0267362 A1
(43) Pub. Date: Sep. 15, 2016

(54) IMAGE FORMING APPARATUS AND IMAGE FORMING METHOD

(71) Applicant: FUJI XEROX CO., LTD., Tokyo (JP)

(72) Inventor: Tomohiro TANIGAWA, Kanagawa (JP)

(73) Assignee: FUJI XEROX CO., LTD., Tokyo (JP)

(21) Appl. No.: 14/826,486

(22) Filed: Aug. 14, 2015

(30) Foreign Application Priority Data
Mar. 12, 2015 (JP) 2015-049021

(51) Int. Cl. G06K 15/02; G06K 15/14

(52) U.S. Cl. CPC G06K 15/021; G06K 15/14; G06K 15/1868; G06K 15/1872; G06K 15/1886; G06K 15/1889; G06K 15/1843; G06K 15/1825

(57) ABSTRACT

An image forming apparatus includes an image forming unit that forms an image on a recording medium, a storage unit that stores information on a characteristic of a preformed image on a recording medium, and a correcting device that corrects, when an additional image is to be formed on the recording medium having the preformed image, magnification of the additional image in a subscanning direction in accordance with the information stored in the storage unit.

### CROSS-REFERENCE TO RELATED APPLICATIONS

This application is based on and claims priority under 35 USC 119 from Japanese Patent Application No. 2015-049021 filed Mar. 12, 2015.

### BACKGROUND

### Technical Field

The present invention relates to an image forming apparatus and an image forming method.

### SUMMARY

According to an aspect of the invention, there is provided an image forming apparatus including an image forming unit that forms an image on a recording medium, a storage unit that stores information on a characteristic of a preformed image on a recording medium, and a correcting device that corrects, when an additional image is to be formed on the recording medium having the preformed image, magnification of the additional image in a subscanning direction in accordance with the information stored in the storage unit.

### BRIEF DESCRIPTION OF THE DRAWINGS

An exemplary embodiment of the present invention will be described in detail based on the following figures, wherein:

FIG. 1 illustrates an outline of an image forming apparatus according to the exemplary embodiment of the present invention;

FIG. 2 is a block diagram illustrating a control system of the image forming apparatus according to the exemplary embodiment of the present invention;

FIG. 3 is a block diagram illustrating an additional printing system of the image forming apparatus according to the exemplary embodiment of the present invention;

FIG. 4 illustrates an image-density-correction-value table stored in the image forming apparatus according to the exemplary embodiment of the present invention; and

FIG. 5 is a flowchart illustrating an exemplary process performed by the image forming apparatus according to the exemplary embodiment of the present invention.

### DETAILED DESCRIPTION

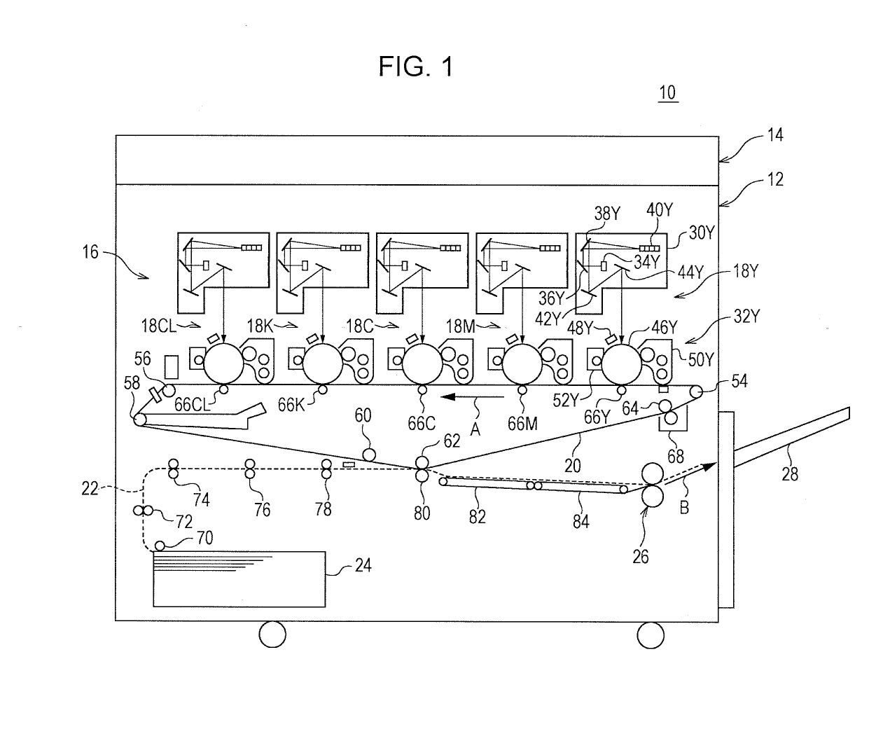

FIG. 1 illustrates an outline of an image forming apparatus 10 according to an exemplary embodiment of the present invention. The image forming apparatus 10 includes an image-forming-apparatus body 12 and an image reading unit 14 that reads an image on a recording medium by scanning the recording medium.

The image-forming-apparatus body 12 includes an image forming section 16 that forms an image on a recording medium by using colored and transparent colorants. The image forming section 16 includes image forming units 18, an intermediate transfer belt 20, a transport path 22, a recording-medium tray 24, a fixing device 26, an output tray 28, and so forth. The image forming section 16 prints an image on a recording medium by using the colorants and in accordance with printing data transmitted from a printing server (not illustrated) that is an external controller as a controller. The printing server accepts an incoming job, processes the accepted job, and transmits the processed job to the image forming section 16.

While the exemplary embodiment concerns a case where an external printing server is used as the controller, the present invention is not limited to such a case. The controller may be incorporated into the image forming apparatus 10. Moreover, the image reading unit 14 does not need to be incorporated into the image forming apparatus 10 and may be provided separately, as an external device, from the image forming apparatus 10.

The image forming section 16 according to the exemplary embodiment includes plural image forming units 18 so that transparent and colored images are formed. Specifically, first to fourth image forming units 18Y, 18M, 18C, and 18K that form images by using colorants having colors of yellow (Y), magenta (M), cyan (C), and black (K), respectively, and a fifth image forming unit 18CL that forms a transparent image by using a transparent (CL) colorant are aligned in that order. The exemplary embodiment concerns a case where the image forming apparatus 10 performs electrophotographic printing by using toner as the colorants. Alternatively, the image forming apparatus 10 may be an inkjet printer. The image forming units 18 are aligned at specific intervals in, for example, the horizontal direction along the intermediate transfer belt 20. The intermediate transfer belt 20 as an intermediate transfer body rotates in a direction of arrow A illustrated in FIG. 1.

The five image forming units 18Y, 18M, 18C, 18K, and 18CL sequentially form toner images in the respective colors in accordance with respective pieces of image data inputted thereto, and the toner images are transferred (for first transfer) to the intermediate transfer belt 20 at respective timings that allow the toner images to be superposed one on top of another. The order in which the image forming units 18Y, 18M, 18C, 18K, and 18CL are aligned is not limited to the above. As long as the image forming unit 18CL is in the last position, the order of the other image forming units 18Y, 18M, 18C, and 18K may be changed in any other way.

The transport path 22 extends below the intermediate transfer belt 20. A recording medium picked up from the recording-medium tray 24 is transported along the transport path 22. The toner images in the respective colors that have been superposed on the intermediate transfer belt 20 are collectively transferred (for second transfer) to the recording medium. The toner images thus transferred to the recording medium are fixed to the recording medium by the fixing device 26. The recording medium having the fixed toner images is discharged to the output tray 28 as illustrated by arrow B.

The first image forming unit 18Y, the second image forming unit 18M, the third image forming unit 18C, the fourth image forming unit 18K, and the fifth image forming unit 18CL are arranged in parallel at specific intervals in the horizontal direction, and all have the same configuration except the colors of images to be formed. Therefore, the first image forming unit 18Y will only be described below. Elements associated with the individual image forming units 18 are distinguished from one another with suffixes Y, M, C, K, and CL given to respective reference numerals.

The image forming unit 18Y includes an optical scanning device 30Y that emits laser light for scanning in accordance with image data inputted thereto, and an image forming device 32Y in which an electrostatic latent image is formed with the laser light scanningly emitted from the optical scanning device 30Y.

The optical scanning device 30Y modulates a semiconductor laser 34Y in accordance with yellow (Y) image data and causes the semiconductor laser 34Y to emit laser light in accordance with the image data. The laser light emitted from the semiconductor laser 34Y is reflected by a first reflecting mirror 36Y and by a second reflecting mirror 38Y, is applied to a rotating polygon mirror 40Y, is deflected back and forth by the rotating polygon mirror 40Y, is reflected by the second reflecting mirror 38Y, by a third reflecting mirror 42Y, and by a fourth reflecting mirror 44Y, and is applied to a photoconductor drum 46Y included in the image forming device 32Y.

The image forming device 32Y includes the photoconductor drum 46Y as an image carrier that rotates at a predetermined speed, a first-charging scorotron 48Y as a charging device that uniformly charges the surface of the photoconductor drum 46Y, a developing device 50Y that develops the electrostatic latent image formed on the photoconductor drum 46Y, and a cleaning device 52Y. The photoconductor drum 46Y is uniformly charged by the scorotron 48Y, and an electrostatic latent image is formed on the charged photoconductor drum 46Y with the laser light emitted from the optical scanning device 30Y. The electrostatic latent image thus formed on the photoconductor drum 46Y is developed into a toner image with yellow (Y) toner by the developing device 50Y. The toner image is then transferred to the intermediate transfer belt 20. After the transfer of the toner image to the intermediate transfer belt 20, residual substances, such as toner particles and paper lint, on the photoconductor drum 46Y are removed by the cleaning device 52Y.

The intermediate transfer belt 20 is stretched with a specific tension around a driving roller 54, a first idler roller 56, a steering roller 58, a second idler roller 60, a backup roller 62, and a third idler roller 64. When the driving roller 54 is rotated by a driving motor (not illustrated), the intermediate transfer belt 20 rotates at a predetermined speed in the direction of arrow A. The intermediate transfer belt 20 is an endless belt obtained by, for example, connecting two ends of a strip of flexible film by fusing or the like. The flexible film is made of synthetic resin such as polyimide.

A first first-transfer roller 66Y, a second first-transfer roller 66M, a third first-transfer roller 66C, a fourth first-transfer roller 66K, and a fifth first-transfer roller 66CL are provided at respective positions of the intermediate transfer belt 20 that are across from the respective image forming units 18Y, 18M, 18C, 18K, and 18CL. The toner images in the respective colors on the respective photoconductor drums 46Y, 46M, 46C, 46K, and 46CL are transferred by the respective first-transfer rollers 66 to the intermediate transfer belt 20 in such a manner as to be superposed one on top of another. Residual toner particles on the intermediate transfer belt 20 are removed by a cleaning blade or a cleaning brush included in a belt cleaning device 68 provided on the downstream side in the direction of rotation of the intermediate transfer belt 20 with respect to a second transfer position.

The transport path 22 is provided with a pickup roller 70 that picks up a recording medium from the recording-medium tray 24; a pair of first rollers 72, a pair of second rollers 74, and a pair of third rollers 76 that transport the recording medium; and a pair of registration rollers 78 that transport the recording medium to the second transfer position at a predetermined timing.

A second transfer roller 80 is provided at the second transfer position on the transport path 22 and is pressed against the backup roller 62. The toner images in the respective colors superposed on the intermediate transfer belt 20 are transferred for the second transfer to the recording medium with a pressing force and an electrostatic force applied thereto by the second transfer roller 80. The recording medium having the toner image in the respective colors is transported to the fixing device 26 by a first transport belt 82 and by a second transport belt 84.

The fixing device 26 heats and presses the recording medium having the toner images in the respective colors, thereby fusing and fixing the toner to the recording medium. The recording medium thus heated and pressed by the fixing device 26 is discharged onto the output tray 28.

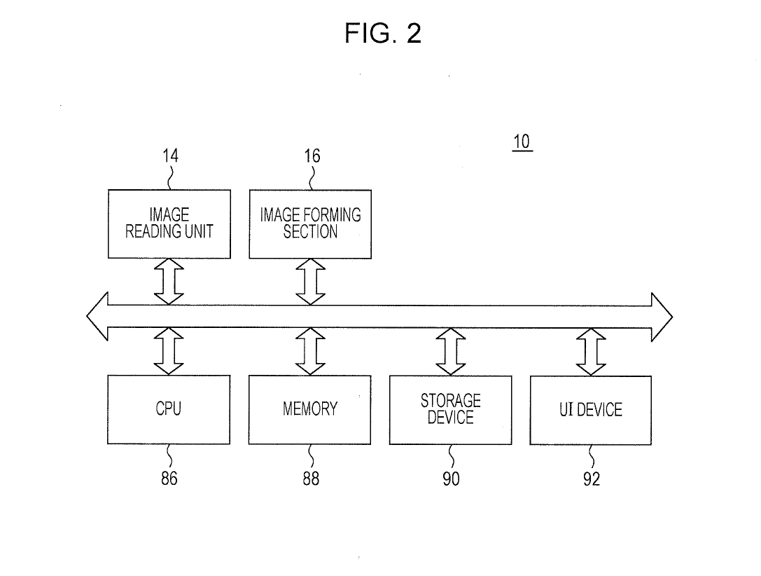

FIG. 2 is a block diagram illustrating a control system of the image forming apparatus 10.

As illustrated in FIG. 2, the image forming apparatus 10 includes the image reading unit 14, the image forming section 16, a central processing unit (CPU) 86, a memory 88, a storage device 90, and a user interface (UI) device 92 that are all connected to a bus line.

The CPU 86 executes any of programs written in the memory 88 and in the storage device 90, thereby controlling the operation of the image forming apparatus 10. Any input accepted by the UI device 92 is transmitted to the CPU 86, and information to be displayed is transmitted from the CPU 86 to the UI device 92.

The CPU 86 may execute any of programs stored in a portable storage medium (not illustrated) such as a compact disc read-only memory (CD-ROM), or any of programs provided thereto from a communication device (not illustrated).

The storage device 90 includes a correction-information storage unit 102, an image-information storage unit 103, and an additional-image-information storage unit 105, which are to be described below. The storage device 90 stores information on characteristics of images on recording media. The storage device 90 is, for example, a hard disk and writably and readably stores data.

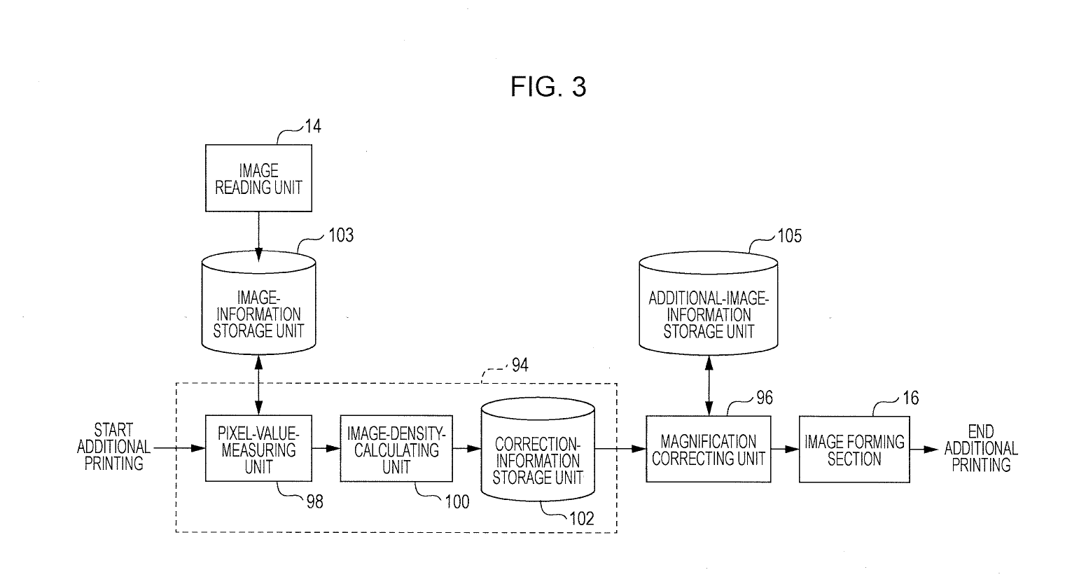

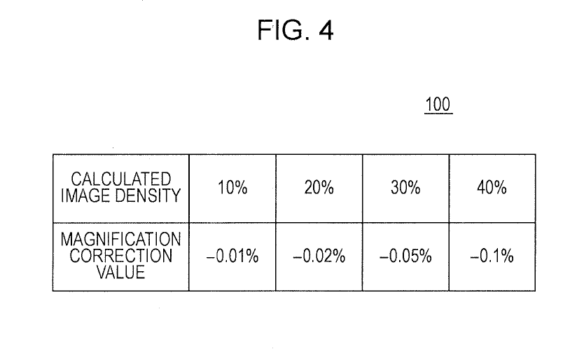

FIG. 3 is a block diagram illustrating an additional printing system of the image forming apparatus 10. FIG. 4 illustrates an image-density-correction-value table 100 that summarizes magnification correction values for different values of calculated image density.

The term “additional printing” used herein refers to forming an additional image on a recording medium having a preformed image (such a recording medium is hereinafter also referred to as “preprinted recording medium”).

As illustrated in FIG. 3, the image forming apparatus 10 according to the exemplary embodiment includes an image-density-calculating device 94 and a magnification correcting unit 96 as a correcting device. The magnification correcting unit 96 corrects the magnification of an additional image.

The image-density-calculating device 94 includes a pixel-value-measuring unit 98, an image-density-calculating unit 100, and the correction-information storage unit 102.

The magnification correcting unit 96 corrects (updates) the value of image magnification stored in the additional-image-information storage unit 105. The additional-image-information storage unit 105 stores information on the additional image for additional printing.

The pixel-value-measuring unit 98 analyzes the density of an image whose information is stored in the image-information storage unit 103, and measures pixel values of that image. The information stored in the image-information storage unit 103 is information on an image formed on a preprinted recording medium, i.e., information on a preformed image, which is read by the image reading unit 14.

The image-density-calculating unit 100 calculates image density from the average of the pixel values measured by the pixel-value-measuring unit 98. Specifically, image density is calculated as follows:

Image density (%)=(255−average pixel value in plane)÷255×100

The correction-information storage unit 102 stores the image-density-correction-value table 100 that summarizes magnification correction values defined for different values of calculated image density. FIG. 4 illustrates an exemplary image-density-correction-value table 100. According to the table 100, the magnification correction value for a calculated image density of 10% is −0.01%, the magnification correction value for a calculated image density of 20% is −0.02%, the magnification correction value for a calculated image density of 30% is −0.05%, and the magnification correction value for a calculated image density of 40% is −0.1%. The negative sign (−) given to the magnification correction values means a reduction in the magnification of the image. The values summarized in the image-density-correction-value table 100 are determined on the basis of experiments.

To summarize, the image-density-calculating device 94 updates the magnification correction values in the image-density-correction-value table 100 in accordance with the image density calculated by the image-density-calculating unit 100. Then, in accordance with the updated magnification correction values, the magnification of the image stored in the additional-image-information storage unit 105 is corrected (updated), and additional printing is executed. Thus, an additional image is formed on a preprinted recording medium.

While the exemplary embodiment concerns a case where image density is taken as the information on characteristics of a preformed image, the information may be any of the kind, the size, the thickness, and other factors of the recording medium. When an additional image is formed on a preprinted recording medium, the expansion rate of the additional image in a subscanning direction varies with the kind, the size, the thickness, and other factors of the recording medium. That is, the present invention is also applicable to a case where a table that summarizes magnification correction values for different kinds, different sizes, different thicknesses, and other different factors of the recording medium is stored, and an additional image is formed on a preprinted recording medium after the value of image magnification stored in the additional-image-information storage unit 105 is corrected (updated) by the magnification correcting unit 96.

In the exemplary embodiment, an additional image is formed as follows: the density of an image on a preprinted recording medium is calculated as the information on characteristics of the preformed image from the average pixel value of that image, the magnification correction values are updated, an additional image is corrected, and the corrected additional image is formed. The present invention is not limited to such a case. The image density may be calculated from the proportion of the area of the image to the area of the recording medium, and the magnification of the additional image may be corrected in accordance with that proportion of the area of the image. As another alternative, the image density may be calculated for each of different predetermined ranges of pixel values, and the magnification of the additional image may be corrected in accordance with a corresponding one of those image density values.

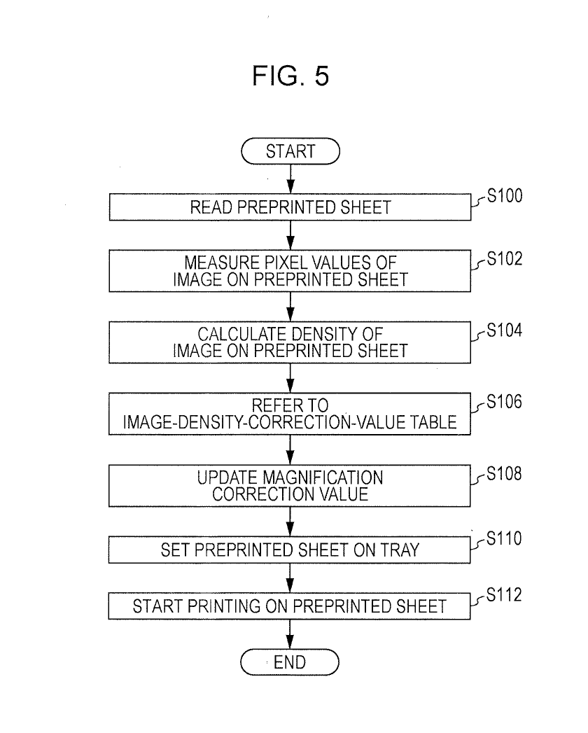

FIG. 5 is a flowchart illustrating an exemplary additional printing process performed by the image forming apparatus 10.

In step 100 (S100), a preprinted sheet as a recording medium having a preformed image is read by the image reading unit 14. Information on the image of the preprinted sheet thus read is stored in the image-information storage unit 103. In step 100 according to the exemplary embodiment, the preprinted sheet has an image composed of the colored colorants excluding the transparent colorant (CL toner).

In step 102 (S102), pixel values of the preprinted sheet are measured from the image information stored in the image-information storage unit 103.

In step 104 (S104), the image density is calculated from the pixel values of the preprinted sheet.

In step 106 (S106), the image-density-correction-value table 100 is referred to for obtaining the magnification correction value that corresponds to the calculated image density.

In step 108 (S108), the magnification correction value stored in the additional-image-information storage unit 105 is updated in accordance with the above magnification correction value determined by referring to the image-density-correction-value table 100.

In step 110 (S110), the preprinted sheet is set on the recording-medium tray 24.

In step 112 (S112), printing on the preprinted sheet is started. What is printed in step 112 is an image composed of the transparent colorant (CL toner) and whose magnification has been corrected. That is, the transparent toner image is formed on the image composed of the colored colorants.

The exemplary embodiment concerns a case where an additional image is formed by using the transparent colorant on a preprinted sheet having an image composed of the colored colorants. The present invention is not limited to such a case and is also applicable to a case where an additional image is formed by using a gold or silver colorant on a preprinted sheet having an image composed of the colored colorants of yellow (Y), magenta (M), cyan (C), and black (K).

As is understood from the above, the present invention is applicable to various image forming apparatuses such as a copier, a facsimile, and a printer.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on a recording medium;
a storage unit that stores information on a characteristic of a preformed image on a recording medium; and
a correcting device that corrects, when an additional image is to be formed on the recording medium having the preformed image, magnification of the additional image in a subscanning direction in accordance with the information stored in the storage unit.

2. The image forming apparatus according to claim 1, further comprising:
an image reading unit that reads an image,
wherein the information on the characteristic of the preformed image on the recording medium that is stored in the storage unit is read by the image reading unit.

3. The image forming apparatus according to claim 1, further comprising:
an image-density-calculating device that calculates the density of an image,
wherein, when an additional image is to be formed on the recording medium having the preformed image, the correcting device corrects the magnification of the additional image in the subscanning direction in accordance with the density of the preformed image on the recording medium.

4. The image forming apparatus according to claim 3, wherein the image-density-calculating device calculates the density of the preformed image from an average pixel value of the preformed image.

5. An image forming method comprising:
forming an image on a recording medium;
storing information on a characteristic of a preformed image on a recording medium; and
correcting, when an additional image is to be formed on the recording medium having the preformed image, magnification of the additional image in a subscanning direction in accordance with the information stored in the storage unit.
